(19) United States
(12) Patent Application Publication
(10) Pub. No.: US 2016/0060487 A1
(43) Pub. Date: Mar. 3, 2016

(54) COMPOSITION AND METHOD FOR POLISHING A SAPPHIRE SURFACE

(71) Applicant: Cabot Microelectronics Corporation, Aurora, IL (US)

(72) Inventor: Steven KRAFT, Naperville, IL (US)

(21) Appl. No.: 14/838,460

(22) Filed: Aug. 28, 2015

Related U.S. Application Data
(60) Provisional application No. 62/043,740, filed on Aug. 29, 2014.

(51) Int. Cl. C09G 1/02

(52) U.S. Cl. CPC C09G 1/02

(57) ABSTRACT

An improved composition and method for polishing a sapphire surface is disclosed. The method comprises abrading a sapphire surface, such as a C-plane, R-plane or A-plane surface of a sapphire wafer, with a polishing composition comprising colloidal silica suspended in an aqueous medium, the polishing composition having an acidic pH and including a sapphire removal rate-enhancing amount of phosphoric acid.

### FIELD OF THE INVENTION

The invention relates to improved compositions and methods for a single step polishing of sapphire surfaces. More particularly, the invention relates to methods for enhancing the sapphire removal rate while achieving a low surface roughness.

### BACKGROUND OF THE INVENTION

Silica abrasive materials are commonly utilized in chemical mechanical polishing of metals, metal oxides, silicon materials. In such applications, abrasive silica particles are suspended in a liquid medium, such as water, sometimes with the aid of a surfactant as a dispersing agent. Choi et al. Journal of the Electrochemical Society, 151 (3) G185-G189 (2004) have reported that addition of sodium chloride, lithium chloride and potassium chloride to suspensions of silica in a basic aqueous medium can enhance the removal rate of silicon dioxide when added to the suspension at levels in the range of about 0.01 to about 0.1 molar. Choi et al. have also reported that removal rates begin to drop back to control levels as the salt concentration is increased beyond 0.1 molar to 1 molar for sodium and lithium salts, and that surface roughness increases for each of the salts as the salt concentration approaches 1 molar, as does the depth of surface damage.

Sapphire is a generic term for alumina (Al₂O₃) single-crystal materials. Sapphire is a particularly useful material for use as windows for infrared and microwave systems, optical transmission windows for ultraviolet to near infrared light, light emitting diodes, ruby lasers, laser diodes, support materials for microelectronic integrated circuit applications and growth of superconducting compounds and gallium nitride, and the like. Sapphire has excellent chemical stability, optical transparency and desirable mechanical properties, such as chip resistance, durability, scratch resistance, radiation resistance, a good match for the coefficient of thermal expansion of gallium arsenide, and flexural strength at elevated temperatures.

Sapphire wafers are commonly cut along a number of crystallographic axes, such as the C-plane (0001 orientation, also called the 0-degree plane or the basal plane), the A-plane (11-20 orientation, also referred to as 90 degree sapphire) and the R-plane (1-102 orientation, 57.6 degrees from the C-plane). R-plane sapphire, which is particularly preferred for silicon-on-sapphire materials used in semiconductor, microwave and pressure transducer application, is about 4 times more resistant to polishing than C-plane sapphire, which is typically used in optical systems, infrared detectors, and growth of gallium nitride for light-emitting diode applications.

The polishing of sapphire wafers is an extremely slow and laborious process. Often, aggressive abrasives, such as diamond must be used to achieve acceptable polishing rates. Such aggressive abrasive materials can impart serious surface damage and contamination to the wafer surface. Typical sapphire polishing involves continuously applying a slurry of abrasive to the surface of the sapphire wafer to be polished, and simultaneously polishing the resulting abrasive-coated surface with a rotating polishing pad, which is moved across the surface of the wafer, and which is held against the wafer surface by a constant down-force, typically in the range of about 5 to 20 pounds per square inch (psi).

Moeggenborg et al. (US20060196849A1) reported an improved process for polishing a sapphire surface comprising abrading the surface with a polishing slurry comprising an inorganic abrasive material suspended in an aqueous medium having a basic pH, preferably about 10 to about 11. They reported that their results indicated that a basic pH is important to the sapphire removal rate enhancing effect of the salt compound additives when used in conjunction with colloidal silica abrasives. However, high pH slurries result in charge repulsion of the abrasive particles from the wafer, resulting in high salt contents and a limit on rate enhancement and surface quality. Therefore, there is an ongoing need for methods to enhance the efficiency of sapphire polishing.

### BRIEF SUMMARY OF THE INVENTION

The present invention provides an improved composition and method for polishing a sapphire surface. The method comprises abrading a sapphire surface, such as a C-plane, R-plane or A-plane surface of a sapphire wafer, with a polishing composition (also known as a polishing slurry) comprising colloidal silica suspended in an aqueous medium having an acidic pH and including a sapphire removal rate-enhancing amount of phosphoric acid. Non-limiting examples of preferred colloidal silica concentrations are about 1 to about 20 percent by weight of the polishing composition. The colloidal silica of the polishing composition has a mean particle size of about 15 to about 200 nm. The pH of the polishing composition is lower than about 6. And the sapphire removal rate-enhancing amount of phosphoric acid is about 0.0001 to about 1.0 percent by weight of the polishing composition.

A preferred method of polishing a sapphire surface comprises applying a polishing composition to a surface of a sapphire wafer mounted in a rotating carrier and abrading the sapphire surface with a rotating polishing pad while maintaining at least a portion of the polishing composition disposed between the polishing surface of the pad and the surface of the sapphire wafer. The polishing composition comprises colloidal silica suspended in an aqueous medium having a pH below about 6 and including a sapphire removal rate-enhancing amount of phosphoric acid. The polishing pad has a planar polishing surface that rotates about an axis of rotation perpendicular to the sapphire surface at a selected rotation rate. The rotating polishing surface of the pad is pressed against the sapphire surface with a selected level of down-force perpendicular to the sapphire surface.

### DESCRIPTION OF EMBODIMENTS

An improved process for polishing a sapphire surface comprises abrading the surface, with a polishing composition comprising colloidal silica suspended in an aqueous medium having an acidic pH. The polishing composition includes a sapphire removal rate-enhancing amount of phosphoric acid. The aqueous medium preferably comprises water.

The polishing composition of the inventive method has an acidic pH (i.e., less than 7). For example, the pH of the polishing composition is about 6.5 or less, about 6 or less, about 5.5 or less, about 5 or less, about 4.5 or less, about 4 or less, about 3.5 or less, about 3 or less, about 2.5 or less, or about 2.0 or less, or about 1.5 or less. Accordingly, the polishing composition can have a pH range bounded by any two of the aforementioned endpoints, for example, about 1.5 to about 7, about 2.0 to about 6.5, about 2.5 to about 6, about 3.0 to about 5.5, about 3.5 to about 5, or about 4 to about 4.5. Typically, the pH of the polishing composition is from about 2.5 to about 5 at the point-of-use.

The phosphoric acid is present in an amount sufficient to enhance the removal rate and enhance surface quality. Typically, the concentration of phosphoric acid in the polishing composition is about 0.0001 percent by weight of the polishing composition (wt. %) or more at the point-of-use, e.g., about 0.0005 wt. % or more, about 0.0015 wt. % or more, about 0.0025 wt. % or more, about 0.005 wt. % or more, about 0.006 wt. % or more, about 0.0075 wt. % or more, about 0.009 wt. % or more, about 0.01 wt. % or more, about 0.025 wt. % or more phosphoric acid at the point-of-use. Alternatively, or in addition to, the polishing composition typically comprises about 1.0 wt. % or less of phosphoric acid at the point-of-use, e.g., about 0.75 wt. % or less, about 0.5 wt. % or less, about 0.3 wt. % or less, about 0.25 wt. % or less phosphoric acid at the point-of-use. Thus, the polishing composition can comprise an amount of phosphoric acid rate bounded by any two of the aforementioned endpoints. As used herein, the terms wt. % and percentage by weight of the polishing composition will be used interchangeably.

In one embodiment, the removal rate-enhancing amount of phosphoric acid is about 0.0001 wt. % to about 1.0 wt. %. Preferably, the phosphoric acid concentration is any concentration in a range between about 0.0001 wt. % to about 1.0 wt. %. For example, the removal rate-enhancing amount of phosphoric acid may be any concentration between about 0.0001 wt. % to about 1.0 wt. %, for example, about 0.0005 wt. % to about 0.5 wt. %, about 0.0007 wt. % to 0.03 wt. %, about 0.001 wt. % to about 0.01 wt. %.

The colloidal silica abrasive preferably has a mean particle size in the range of about 20 to about 200 nm, more preferably 20 to about 50 nm. The colloidal silica can have any suitable mean particle size between about 20 and 200 nm. For example, the colloidal silica may have a mean particle size of about 25 nm or greater, 30 nm or greater, 50 nm or greater, 75 nm or greater. Additionally, the colloidal silica may have a mean particle size of about 200 nm or less, 150 nm or less, 100 nm or less, 75 nm or less, 50 nm or less. Thus, the colloidal silica particles can have an average particle size bounded by any two of the aforementioned endpoints.

Preferably, the colloidal silica is suspended in an aqueous medium at a concentration of about 0.5 percent by weight of the polishing composition (wt. %) or higher, for example about 0.75 wt. % or higher, about 1 wt. % or higher, about 2 wt. % or higher, about 3 wt. % or higher. Additionally, the colloidal silica may be suspended in an aqueous medium at a concentration of about 20 wt. % or less, about 15 wt. % or less, about 10 wt. % or less, about 5 wt. % or less. The colloidal silica may be present in any suitable concentration range bounded by the ranges above, for example, about 0.5 to about 20 wt. %, about 0.75 to about 20 wt. %, about 1 to about 20 wt. %, about 1 to about 10 wt. %, about 2 to about 10 wt. %.

Non-limiting examples of suitable colloidal silica useful in the methods of the present invention include the BINDZIL® brand colloidal silica slurries marketed by EKA Chemicals division of Akzo Nobel, such as BINDZIL® CJ2-0 (about 40 weight percent silica, about 110 nm mean particle size), 30/220 (about 30 weight percent silica, about 15 nm mean particle size), 50/80 (about 50 weight percent silica, about 90 nm mean particle size), 40/130 (about 40 weight percent silica, about 40 nm mean particle size), 30/80 (about 30 weight percent silica, about 40 nm mean particle size), SP599L (about 40 weight percent silica, about 90 nm mean particle size), 40/220 (about 40 weight percent silica, about 15 nm mean particle size), colloidal silica materials marketed by Nalco Chemical Company, such as TX11005 (about 30 weight percent by weight silica, about 50 nm mean particle size), 1040a (about 34 weight percent silica, about 20 nm mean particle size), 1142 (about 40 weight percent silica, about 15 nm mean particle size), 2360 (about 50 weight percent silica, about 60 nm mean particle size), 2329K (about 40 weight percent silica, about 80 nm mean particle size), 13573 (about 27 weight percent silica, about 40 nm mean particle size), DVSTS028 (about 30 weight percent silica, about 17 nm mean particle size), DVST2027 (about 30 weight percent silica, about 35 nm mean particle size), DVST006 (about 40 weight percent silica, about 55 nm mean particle size), DVSTS030 (about 47 weight percent silica, about 15 nm mean particle size), 2329PLUS (about 47 weight percent silica, about 105 nm mean particle size), 2350 (about 50 weight percent silica, about 60 nm mean particle size), 2354 (about 50 weight percent silica, about 60 nm mean particle size), 2358 (about 30 weight percent silica, about 85 nm mean particle size), 2360 (about 50 weight percent silica, about 60 nm mean particle size), 2398 (about 30 weight percent silica, about 85 nm mean particle size), colloidal silica marketed by Fuso, such as Fuso PL-2L (about 20 weight percent silica, about 18 nm mean particle size), PL-3 (about 20 weight percent silica, about 35 nm mean particle size), PL-3D (about 20 weight percent silica, about 35 nm mean particle size), PL-7 (about 25 weight percent silica, about 75 nm mean particle size), SH-7D (about 34 weight percent silica, about 75 nm mean particle size), PL-7H (about 25 weight percent silica, about 70 nm mean particle size), PL-5 (about 25 weight percent silica, about 60 nm mean particle size), PL-1 (about 12 weight percent silica, about 15 nm mean particle size), PL-2 (about 20 weight percent silica, about 25 nm mean particle size), PL-2L (about 20 weight percent silica, about 18 nm mean particle size), PL-10 (about 25 weight percent silica, about 90 nm mean particle size), BS-2H (about 20 weight percent silica, about 30 nm mean particle size), HL-2 (about 20 weight percent silica, about 27 nm mean particle size), and the like.

The methods of the present invention are particularly useful for polishing, or planarizing, a C-plane, R-plane or A-plane surface of a sapphire wafer. The methods of the present invention provide material removal rates for polishing sapphire surfaces significantly higher than removal rates achieved with conventional abrasive slurries, while still maintaining a high level of surface quality.

The methods of the present invention can be carried out utilizing any suitable polishing equipment. The methods of the present invention may utilize any suitable polishing pad and polishing equipment. In one embodiment, the polishing is accomplished with sapphire wafers mounted in a rotating carrier, using a rotating polishing pad applied to the surface of the wafers at a selected down-force. For example, the polishing is accomplished with a down-force in the range of about 2 to about 20 psi at a pad rotation rate in the range of about 20 to about 150 revolutions per minute (rpm), with the wafers mounted on a carrier rotating at about 20 to about 150 rpm. Suitable polishing equipment is commercially available from a variety of sources, such as Logitech Ltd, Glasgow, Scotland, UK and SpeedFam-IPEC Corp., Chandler, Ariz., as is well others well known in the art.

The methods of the present invention can be carried out utilizing a polishing composition that additionally comprises various catalysts, polymers, surfactants, and salts for rate-enhancement and/or surface roughness enhancement. The methods of the present invention can be carried out utilizing a polishing composition that optionally further comprises one or more additives. Illustrative additives include conditioners, complexing agents, chelating agents, biocides, scale inhibitors, dispersants, etc.

A biocide, when present, can be any suitable biocide and can be present in the polishing composition in any suitable amount. A suitable biocide is an isothiazolinone biocide. The amount of biocide present in the polishing composition, when present, typically is about 1 to about 50 ppm, preferably about 10 to about 20 ppm at the point-of-use.

It will be understood that any of the components of the polishing composition that are acids, bases, or salts (e.g., anionic surfactant, buffer, etc.), when dissolved in the aqueous medium of the polishing composition, can exist in dissociated form as cations and anions. The amounts of such compounds present in the polishing composition as recited herein will be understood to refer to the weight of the undissociated compound used in the preparation of the polishing composition.

The following examples further illustrate the invention but, of course, should not be construed as in any way limiting its scope.

### EXAMPLE 1

C-plane sapphire wafers (approximately 2 inches diameter) were polished a Logitech CDP polisher. The wafers were mounted on the carrier, which was rotating at a carrier speed of about 65-69 rpm. A Suba™ 600 XY grooved polishing pad (Dow Chemical Company, Midland, Mich.) rotating at a platen speed of about 69 rpm was utilized at an applied down-force of about 5 psi. The pad was conditioned with a TBW diamond grit conditioner (TBW Industries, Inc., Furlong, Pa.).

As used herein, the terms polishing slurry and polishing composition are used interchangeably. The different polishing slurry treatments are described in Table 1. The solids represent colloidal silica with a mean particle size of about 25-45 nm. The wafers were polished for 7 minutes, and then analyzed for removal rate and surface roughness. Removal rates were calculated from the weight difference of the wafer before and after polishing. The average surface roughness was determined by atomic force microscopy (AFM) with a Veeco D5000 instrument (Veeco Instruments, Inc., Plainview, N.Y.).

The results of the polishing experiments are shown in Table 1. Addition of phosphoric acid in a polishing slurry at an acidic pH, with colloidal silica, resulted in both an increase in removal rate and improved surface quality. For example, at slurry pH values above 7, the average surface roughness was high (i.e., comparative treatments 1A, 1C, 1G, 1I and 1U) or the removal rate was low (i.e., comparative treatments 1B, 1D, and 1T). By comparison, when the slurry pH was acidic, the average surface roughness was low, ranging between 0.72 and 2.13 angstroms, while removal rates were high (i.e., 191 to 403 Å/min). A removal rate of up to 403 Å/minute was observed at pH 4.0, 0.006 wt. % phosphoric acid, and 5 wt. % colloidal silica (inventive slurry 1M).

Without wishing to be bound by any particular theory, it is possible that at acidic pH, the phosphoric acid binds to the colloidal silica and aids in allowing the particle to contact the sapphire surface, thereby increasing the likelihood of the particle/surface interaction. The silanol groups on the colloidal silica particle may react with the sapphire surface, making the sapphire “softer” and thereby able to be polished by colloidal silica.

TABLE 1

| | Solids | Phosphoric | | Removal Rate | Ave. Surface |
|---|---|---|---|---|---|
| | Content | Acid | | C-plane | Roughness |
| Trmt | (wt. %) | (wt. %) | pH | (Å/min) | (Å) |
| Comp. 1A | 10 | 0 | 10 | 143 | 3.88 |
| Comp. 1B | 20 | 0 | 9.4 | 43 | 2.20 |
| Comp. 1C | 20 | 0 | 2.5 | 101 | 5.54 |
| Comp. 1D | 20 | 0 | 2.5 | 70 | 1.37 |
| Comp. 1E | 20 | 0 | 9.0 | 240 | 4.07 |
| Comp. 1F | 20 | 0.03 | 9.0 | 117 | 2.66 |
| Comp. 1G | 20 | 0 | 9.0 | 246 | 4.08 |
| 1H | 20 | 0.03 | 2.5 | 191 | 1.96 |
| Comp. 1I | 20 | 0.03 | 9.0 | 164 | 3.34 |
| 1J | 10 | 0.015 | 3.0 | 255 | — |
| 1K | 10 | 0.015 | 3.5 | 369 | 0.94 |
| 1L | 5 | 0.0075 | 3.0 | 341 | 0.72 |
| 1M | 5 | 0.006 | 4.0 | 403 | 1.59 |
| 1N | 5 | 0.0075 | 5.0 | 316 | 1.66 |
| 1O | 4 | 0.0045 | 4.0 | 320 | 1.58 |
| 1P | 3 | 0.0045 | 3.5 | 288 | 1.67 |
| 1Q | 2.5 | 0.0038 | 3.5 | 236 | 1.48 |
| 1R | 1 | 0.0015 | 3.0 | 292 | 1.26 |
| 1S | 1 | 0.0015 | 4.1 | 295 | 2.13 |
| Comp. 1T | 0.33 | 0.0015 | 4.0 | 149 | 1.86 |
| Comp. 1U | 0.2 | 0.0006 | 4.0 | 156 | 7.47 |

### EXAMPLE 2

R-plane and A-plane sapphire wafers (approximately 2 inches diameter) were polished on a Logitech CDP polisher. As described in Example 1, the wafers were mounted on the carrier, which was rotating at a carrier speed of about 65-69 rpm. A Suba™ 600 XY grooved polishing pad rotating at a platen speed of about 69 rpm was utilized at an applied down-force of about 5 psi. The pad was conditioned with a TBW diamond grit conditioner.

Slurries were prepared as described in Tables 2 and 3. The solids represent colloidal silica with a mean particle size of about 25-45 nm. The wafers were polished for 7 minutes, and then analyzed for removal rate and surface roughness. As before, removal rates were determined by weight difference of the wafer before and after polishing. The average surface roughness was determined by atomic force microscopy (AFM) with a Veeco D5000 instrument.

The results of the polishing experiments for R-plane sapphire substrates are shown in Table 2, while the results for A-plane sapphire substrates is shown in Table 3. Addition of phosphoric acid, in compositions having an acidic pH, and with colloidal silica between 0.5 and 20 wt. %, resulted in both an increase in removal rate and surface quality. For example, at pH values above 5, the average surface roughness was higher than the inventive treatments at an acidic pH. For example, at 10% solids content, treatment 3A had an average surface roughness of 5.42 Å, while treatment 3B containing 0.015 wt. % phosphoric acid, had an average surface roughness of 0.96 Å. By comparison, when the pH was at 5 or below, the average surface roughness ranged between 0.91 and 2.13 angstroms. Additionally, removal rates of up to 93 and 61 angstroms/minute (for R and A-plane respectively) were observed at pH 4.0, 0.006 wt. % phosphoric acid, and 5 wt. % colloidal silica.

TABLE 2

| | Solids | Phosphoric | | Removal Rate | Ave. Surface |
|---|---|---|---|---|---|
| | Content | Acid | | R-plane | Roughness |
| Trmt | (wt. %) | (wt. %) | pH | (Å/min) | (Å) |
| Comp. 2A | 10 | 0 | 10 | 63 | 2.55 |
| 2B | 5 | 0.0075 | 4.0 | 93 | 2.73 |
| 2C | 1 | 0.0015 | 3.6 | 46 | 2.13 |

TABLE 3

| | Solids | Phosphoric | | Removal Rate | Ave. Surface |
|---|---|---|---|---|---|
| | Content | Acid | | A-plane | Roughness |
| Trmt | (wt. %) | (wt. %) | pH | (Å/min) | (Å) |
| Comp. 3A | 10 | 0 | 10 | 51 | 5.42 |
| 3B | 10 | 0.015 | 3.5 | 61 | 0.96 |
| 3C | 5 | 0.0075 | 4.0 | 61 | 1.16 |
| 3D | 2.5 | 0.0038 | 3.5 | 31 | 0.94 |
| 3E | 1 | 0.0015 | 3.6 | 23 | 1.06 |

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as” or “for example”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of polishing a sapphire surface comprising abrading the sapphire surface with a polishing composition comprising colloidal silica at about 0.5 to about 20 percent by weight of the polishing composition suspended in an aqueous medium, the polishing composition having an acidic pH and including a sapphire removal rate-enhancing amount of phosphoric acid of about 0.0001 to about 1.0 percent by weight of the polishing composition.

2. The method of claim 1 wherein the colloidal silica is between about 1 and about 10 percent by weight of the polishing composition.

3. The method of claim 1 wherein the colloidal silica has a mean particle size in the range of about 20 to about 200 nm.

4. The method of claim 1 wherein the colloidal silica has a mean particle size in the range of about 20 to about 50 nm.

5. The method of claim 1 wherein the polishing composition has a pH lower than about 6.

6. The method of claim 1 wherein the polishing composition has a pH in the range of about 2.5 to about 5.

7. The method of claim 1 wherein the removal rate-enhancing amount of phosphoric acid is about 0.0005 to about 0.5 percent by weight of the polishing composition.

8. The method of claim 1 wherein the removal rate-enhancing amount of phosphoric acid is about 0.0007 to about 0.03 percent by weight of the polishing composition.

9. The method of claim 1 wherein the aqueous medium comprises water.

10. The method of claim 1 wherein the sapphire surface is a C-plane sapphire surface.

11. The method of claim 1 wherein the sapphire surface is an R-plane sapphire surface.

12. The method of claim 1 wherein the sapphire surface is an A-plane sapphire surface.

13. A method of polishing a sapphire surface comprising:
(a) applying a polishing composition to a surface of a sapphire wafer mounted in a rotating carrier, the polishing composition comprising colloidal silica having a mean particle size in the range of about 15 to about 200 nm, suspended in an aqueous medium, the polishing composition having an acidic pH lower than about 6, and including a sapphire removal rate-enhancing amount of phosphoric acid of about 0.0001 to about 1.0 percent by weight of the polishing composition; and
(b) abrading the surface of the wafer with a polishing pad having a planar polishing surface rotating at a selected rotation rate about an axis perpendicular to the surface of the wafer, the polishing surface of the pad being pressed against the surface of the wafer with a selected level of down-force perpendicular to the surface of the wafer, with at least a portion of the polishing composition disposed between the polishing surface of the pad and the surface of the sapphire wafer, to remove sapphire from the surface of the wafer.

14. The method of claim 13 wherein the colloidal silica is present at a concentration in the range of about 1 to about 20 percent by weight of the polishing composition.

15. The method of claim 13 wherein the removal rate-enhancing amount of phosphoric acid is about 0.0007 to about 0.03 percent by weight of the polishing composition.

16. The method of claim 13 wherein the polishing composition has a pH in the range of about 2.5 to about 5.

17. The method of claim 13 wherein the colloidal silica has a mean particle size in the range of about 20 to about 50 nm.

18. The method of claim 13 wherein the sapphire surface is a C-plane sapphire surface.

19. The method of claim 13 wherein the sapphire surface is an R-plane sapphire surface.

20. The method of claim 13 wherein the sapphire surface is an A-plane sapphire surface.
